(19) United States
(12) Patent Application Publication
(10) Pub. No.: US 2007/0216067 A1
(43) Pub. Date: Sep. 20, 2007

(54) Macrocyclic polyester oligomers as carriers and/or flow modifier additives for thermoplastics

(75) Inventors: Steven R. Bahr, Schenectady, NY (US); Nathan Doyle, Troy, NY (US); Jing Wang, Clifton Park, NY (US); Steven J. Winckler, Troy, NY (US); Tohru Takekoshi, Scotia, NY (US); Yi-Feng Wang, Clifton Park, NY (US)

Correspondence Address: GOODWIN PROCTER LLP;PATENT ADMINISTRATOR, EXCHANGE PLACE, BOSTON, MA, 02109-2881, US

(73) Assignee: Cyclics Corporation, Schenectady, NY (US)

(21) Appl. No.: 11/607,464

(22) Filed: Dec. 1, 2006

Related U.S. Application Data
(63) Continuation-in-part of application No. 11/260,509, filed on Oct. 27, 2005, now Pat. No. 7,230,044.
Application No. 11/260,509 is a continuation of application No. 10/859,784, filed on Jun. 3, 2004, now Pat. No. 6,960,626.
Application No. 10/859,784 is a continuation-in-part of application No. 10/408,753, filed on Apr. 7, 2003, now Pat. No. 6,994,914.
Application No. 10/408,753 is a continuation of application No. 10/195,853, filed on Jul. 15, 2002, now Pat. No. 6,639,009.
Application No. 10/195,853 is a continuation of application No. 09/754,943, filed on Jan. 4, 2001, now Pat. No. 6,420,047.
Application No. 09/754,943 is a continuation-in-part of application No. 09/535,132, filed on Mar. 24, 2000, now Pat. No. 6,369,157.
(63) Continuation-in-part of application No. 11/015,339, filed on Dec. 17, 2004.
(60) Provisional application No. 60/830,879, filed on Jul. 14, 2006.
(60) Provisional application No. 60/177,727, filed on Jan. 21, 2000.
(60) Provisional application No. 60/530,942, filed on Dec. 19, 2003.

(51) Int. Cl. C08G 18/42; B29B 7/00

(52) U.S. Cl. 264/328.1; 524/500; 524/599; 977/735; 977/742

(57) ABSTRACT

Concentrates of a carbon-based filler—such as carbon nanotubes, exfoliated graphite, and the like—and a macrocyclic polyester oligomer (also referred to herein as macrocyclic oligoester or MPO) are presented. When mixed with polymer, the MPO can act as a flow modifier, as well as a carrier for the carbon-based filler, allowing enhanced processability of the polymer-filler composite without adversely affecting the properties of the composite.

### PRIOR APPLICATIONS

This application claims benefit of U.S. Provisional Patent Application No. 60/830,879, filed on Jul. 14, 2006, the description of which is incorporated herein by reference in its entirety. This application is also a continuation-in-part of U.S. patent application Ser. No. 11/260,509, filed on Oct. 27, 2005, which is a continuation of U.S. patent application Ser. No. 10/859,784, filed on Jun. 3, 2004, which is a continuation-in-part of U.S. patent application Ser. No. 10/408,753, filed on Apr. 7, 2003, which is a continuation of U.S. patent application Ser. No. 10/195,853, filed on Jul. 15, 2002, and issued as U.S. Pat. No. 6,639,009, which is a continuation of U.S. patent application No. 09/754,943, filed on Jan. 4, 2001, and issued as U.S. Pat. No. 6,420,047, which is a continuation-in-part of U.S. patent application Ser. No. 09/535,132, filed on Mar. 24, 2000, and issued as U.S. Pat. No. 6,369,157, which claims benefit of U.S. Provisional Patent Application No. 60/177,727, filed on Jan. 21, 2000, the descriptions of which are incorporated herein by reference in their entirety. This application is also a continuation-in-part of U.S. patent application Ser. No. 11/015,339, filed on Dec. 17, 2004, which claims benefit of U.S. Provisional Patent Application No. 60/530,942, filed on Dec. 19, 2003, the descriptions of which are incorporated herein by reference in their entirety.

### FIELD OF THE INVENTION

This invention relates generally to thermoplastics and articles formed therefrom. More particularly, in certain embodiments, the invention relates to composites of polymer and carbon-based material using macrocyclic polyester oligomer as a carrier.

### BACKGROUND OF THE INVENTION

Semi-crystalline polymers are useful as engineering thermoplastics because they possess advantageous chemical, physical, and electrical properties, and because they can be readily processed by thermal means. For example, linear semi-crystalline polymers such as polyethylene terephthalate (PET) and polybutylene terephthalate (PBT) are processed by injection molding and extrusion in the manufacture of plastic components.

Fillers may be added to polyester to form composites having advantageous properties. For example, fillers may be added to provide strength, color, or density, or fillers may be added to facilitate processing or to serve as a substitute for a more expensive material.

A filler having a high aspect ratio may be added, for example, to provide an increase in the stiffness and/or modulus of a resulting composite or to achieve a particular balance of properties. For example, a composite made with a layered mineral such as montmorillonite or aluminosilicate exhibits increased tensile modulus, even with relatively small amounts of high-aspect-ratio filler added. Furthermore, plate-like fillers having particles that are on the order of 100 nm or more in width and on the order of about 1 nm in thickness may be used in composite membranes to increase molecular diffusion path lengths, thereby improving gas barrier properties of the membrane.

Graphite is a high-aspect-ratio, layered mineral that has high electrical and thermal conductivities. Polymer composites containing adequately-dispersed graphite may exhibit greatly enhanced electrical and/or thermal conductivities. These composites are useful, for example, in the production of anti-static parts, electromagnetic shields, and heat sinks. The property enhancement due to the presence of graphite depends on the average inter-particle distance and/or connectivity in the polymer matrix. Thus, smaller, better-dispersed particles in the composite may result in higher electrical and/or thermal conductivities. Furthermore, it may be possible to use less graphite in order to achieve a desired increase in electrical and/or thermal conductivity if the graphite is sufficiently dispersed in the polymer matrix.

It is difficult to achieve an adequate dispersion of graphite in polymer, due to the natural structure of graphite. Graphite is a sheet-like layered mineral with an inter-layer distance of about 3.35 Å. Because of strong Van der Waals forces between layers of graphite, it is difficult to separate the layers by simple mixing. However, it is possible to separate layers of graphite by chemical means. Exfoliated graphite has been prepared by intercalating layers of graphite with strong acid, such as sulfuric or nitric acid, then thermally decomposing the acid-intercalated graphite into separate sheets of exfoliated graphite.

Still, adequate dispersion of exfoliated graphite in polyester is difficult to achieve, due to the greatly increased viscosity attributable to the exfoliated graphite. Laboratory experiments have been described in which exfoliated graphite was mixed with polystyrene monomer precursors, which were then polymerized to produce a graphite-containing polystyrene composite (P. Xiao, M. Xiao, and K. Gong, Polymer, 42, 4813, 2001). However, laboratory production of polymer composites other than polystyrene composites was not described in this article. Furthermore, large-scale manufacture of such composites poses material handling challenges, for example, due to the high viscosity of polymerizing material and the long thermal cycle times typically needed where processing temperatures exceed the melting point of the polymer being produced.

Also, the adjustment of melt flow properties of linear thermoplastics is typically handled by adjusting the molecular weight of the polymer. For example, two or more grades of polymer, each having a different average molecular weight, may be mixed to provide a polymer composition with adequate melt flow rate in an injection molding process. The presence of a filler such as graphite or other carbon-based material may make injection molding more difficult, requiring lower viscosity polymer and mixing of various polymer grades to facilitate injection of the composition into a mold (or other processing step).

There exists a need for polymer composites with sufficient filler dispersion to allow the composite to conduct electricity at relatively low filler loadings and/or to exhibit other desired properties. There is also a need for simpler, more versatile, and lower-cost methods of manufacturing such composites.

### SUMMARY OF THE INVENTION

Concentrates of a carbon-based filler—such as carbon nanotubes, exfoliated graphite, and the like—and a macrocyclic polyester oligomer (also referred to herein as macrocyclic oligoester or MPO) are presented. When mixed with polymer, the MPO can act as a flow modifier, as well as a carrier for the carbon-based filler, allowing enhanced processability of the polymer-filler composite without adversely affecting the properties of the composite.

It has been discovered that carbon-based materials such as exfoliated graphite readily disperse in certain molten macrocyclic polyester oligomers without excessive increase in melt viscosity and without the need for solvents. For example, measured values of volume resistivity show that composites containing even relatively small amounts of exfoliated graphite demonstrate significantly greater electrical conductivities than composites without exfoliated graphite. This facilitates the production of electrically and thermally conductive polyester composites that contain relatively low amounts of graphite or other carbon-based material. It is therefore possible to manufacture composites with desired electrical and/or thermal conductivity, while avoiding adversely affecting desired properties of the polyester due to the presence of too much conductive filler in the composite. For example, it is possible to manufacture a graphite-polyester composite with high enough electrical and/or thermal conductivity for use in the production of anti-static parts, electromagnetic shields, and/or heat sinks, without substantially increasing density and without substantially decreasing impact resistance due to the presence of the conductive filler in the composite.

Furthermore, it has been discovered that macrocyclic polyester oligomers, as well as certain other cyclic oligomers, can be used as additives in compositions of linear thermoplastics for improved flow and/or processability. In this way, for example, it is possible for resin manufacturers, compounders, and injection molders to vary the melt flow of a polymer having a particular molecular weight (or molecular weight range) by adding a small amount of cyclic oligomer, rather than by mixing several base grades having different molecular weights.

Therefore, the invention provides methods of preparing a composite by mixing or otherwise contacting a polymer with a masterbatch, the masterbatch containing MPO and a high concentration of carbon-based filler, such as carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, buckytubes, and the like. The use of MPO facilitates masterbatching of high aspect-ratio filler such as those above, improves processability of the composite, and allows improved dispersion of the carbon-based filler in the polymer, all with negligible or no adverse affect on the desired properties of the composite.

Accordingly, the invention provides mixtures of MPO and carbon-based materials, as well as methods for preparing and using such mixtures. For example, the invention provides stable mixtures of MPO with exfoliated graphite, which can be polymerized to form polymer compositions having high electrical and/or thermal conductivity. In certain embodiments, the presence of the graphite (or other conductive filler) in the MPO composite does not significantly affect the polymerization rate of the MPO, nor is percent conversion or average molecular weight of the resulting polymer significantly affected.

MPO exhibits low melt viscosity and polymerizes at temperatures well below the melting point of the resulting polymer. Thus, melt flow, polymerization, and crystallization can occur isothermally and, therefore, the time and expense required to thermally cycle a tool is favorably reduced. Furthermore, the low viscosity of the MPO allows it to impregnate dense fibrous preforms. For example, even upon addition of exfoliated graphite, the viscosity of mixtures with certain MPO's stays low enough to facilitate further processing, improving its versatility. For example, the viscosity of mixtures of cyclic poly(butylene terephthalate) with 5 wt. % exfoliated graphite is low enough to allow stirring with a conventional laboratory paddle stirrer at a temperature of about 150° C. (below about 1000 cP).

Improved melt flow rate is demonstrated herein using macrocyclic polyester oligomers (MPOs) as additives for thermoplastics, in amounts less than 5 wt. %, without significant effects on the other properties of the resulting compositions, such as toughness, strength, and impact resistance. In certain embodiments, the amount of MPO used as flow modifier additive is less than about 10 wt. %, less than about 7 wt. %, less than about 3 wt. %, less than about 2 wt. %, less than about 1 wt. %, or less than about 0.5 wt. %.

It is also demonstrated herein that macrocyclic polyester oligomers may be used as additives in linear polymers in an injection molding process for producing bottle preforms. The use of the cyclic oligomers provides improved flow, reduced molding pressure, and reduced energy consumption, with negligible effect on properties of the bottle preforms or the bottles themselves. The optical properties and acetaldehyde content of bottles blown from these preforms are substantially unaffected by the use of the macrocyclic polyester oligomers.

In certain embodiments, a pressure reduction can be achieved in an injection molding process. A pressure reduction of about 20% was demonstrated with a thermoplastic composition containing about 2 wt. % macrocyclic poly(butylene terephthalate) oligomer as flow modifier. The improved flow of compositions in the injection molding of thermoplastics provides, for example, lower molding pressures and lower part stress. This results in a reduced energy requirement, improved throughput, and increased productivity, and the ability, for example, to injection mold larger parts and/or parts with thinner wall sections. The benefits of lower molded part stress may be observed, for example, in reduced warpage, improved dimensional stability, and lower birefringence of the molded product.

The need to mix multiple grades of linear polymers in the manufacturing of thermoplastic parts may be eliminated or reduced, since embodiments of the invention allow more versatile use of linear polymer of a given grade. This may lead, for example, to an improvement in overall compounding throughput, and may allow increased usage of recycled and/or other commercial grades of thermoplastics.

In one aspect, the invention provides a method for preparing a composite, for example, a nanocomposite, including the step of contacting a polymer with a masterbatch containing MPO and a carbon-based material, such as carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, and buckytubes, and the like. In certain embodiments, it is beneficial to create an MPO-filler masterbatch having a relatively high filler content that is well-dispersed in the MPO. The masterbatch can then be mixed, for example, with an engineering resin, such as polyethylene terephthalate (PET) or polybutylene terephthalate (PBT) using standard mixing techniques. The use of the masterbatch in this method can simplify material handling, since the method allows less intensive mixing of masterbatch and polymer at the expense of more intensive mixing/dispersal of filler (i.e. carbon nanotubes and/or powdered, exfoliated graphite) in a relatively small amount of MPO. It is therefore possible to avoid poor filler dispersion and other problems posed by incorporating high aspect-ratio fillers directly into a thermoplastic engineering resin. The masterbatch may contain at least about 5, about 10, about 15, about 20, about 25, about 30, about 35, about 40, about 45, about 50, about 55, about 60, about 65, or about 70 wt. % carbon-based filler, for example. In other embodiments, the masterbatch may contain more filler or less filler than these amounts. In a preferred embodiment, the filler is exfoliated graphite. In a preferred embodiment, the filler particles have a size on the order of 0 to about 100 nanometers in at least one dimension. In one embodiment, the contacting step includes contacting the masterbatch with an engineering resin including the polymer, where the polymer may include, for example, PET, PBT, or both. In one embodiment, the polymer is thermoplastic. In a preferred embodiment, the composite is electrically conductive, thermally conductive, or both.

In certain embodiments, the carbon-based material makes up at least about 10 wt. % of the masterbatch, at least about 20 wt. % of the masterbatch, at least about 30 wt. % of the masterbatch, at least about 40 wt. % of the masterbatch, or at least about 50 wt. % of the masterbatch, or more. The carbon-based material may include carbon nanotubes—for example, single walled carbon nanotubes, multi-wall carbon nanotubes, or both. The carbon nanotubes may be functionalized (i.e. with —OH and/or —COOH groups) or nonfunctionalized. In certain embodiments, the carbon nanotubes may include single wall nanotubes having an outer diameter from about 1 to about 2 nm, an inside diameter from about 0.8 to about 1.6 nm, and an average particle size from about 0.5 to about 2 nm. In certain embodiments, the carbon nanotubes include multi-wall carbon nanotubes having an outer diameter from less than about 8 nm to about 15 nm, an inside diameter from about 2 to about 5 nm, and a length from about 10 to about 50 micrometers. In certain embodiments, the nanotubes are about 30 to about 70 micrometers long; however, “short” nanotubes of length from about 0.5 micrometers to about 2 micrometers may be used. Carbon nanotubes, and/or other similar materials, may be used having these dimensions or different dimensions. Industrial grade carbon nanotubes may be used, or higher grade (i.e. higher purity) carbon nanotubes may be used.

In certain embodiments, the MPO includes a macrocyclic poly(alkylene dicarboxylate) oligomer having a structural repeat unit of the formula: 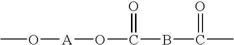
where A is an alkylene, or a cycloalkylene or a mono- or polyoxyalkylene group; and B is a divalent aromatic or alicyclic group. For example, the MPO may include one or more of the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and/or copolyester oligomer comprising two or more monomer repeat units.

In one embodiment, the polymer includes a polyester, a polyolefin, a polyformal, a polyphenylene oxide, a polyphenylene sulfide, a polyphenylsulfone, a polyetherimide, and/or a co-polymer of any of these, or any combination of these. In one embodiment, the polymer includes a polyester, for example, polybutylene terephthalate (PBT), polyethylene terephthalate (PET), and/or co-polyester thereof. In certain embodiments, the polymer is a linear polymer.

In certain embodiments, the polymer includes a thermoplastic polymer, although in other embodiments, the polymer may include a thermoset.

Preferably, the composite is electrically conductive, thermally conductive, or both. In certain embodiments, the composite is a nanocomposite. In certain embodiments, the carbon-based material makes up no more than about 5 weight percent of the composite, yet the composite is electrically conductive. In certain embodiments, the carbon-based material makes up no more than about 7 weight percent of the composite, yet the composite is electrically conductive. In certain embodiments, the carbon-based material makes up no more than about 4 weight percent of the composite, yet the composite is electrically conductive. In certain embodiments, the carbon-based material makes up no more than about 3 weight percent of the composite, yet the composite is electrically conductive.

In certain embodiments, the carbon-based material makes up less than or equal to about 10 weight percent of the composite, less than or equal to about 7 weight percent of the composite, less than or equal to about 5 weight percent of the composite, less than or equal to about 3 weight percent of the composite, less than or equal to about 2 weight percent of the composite, or less than or equal to about 1 weight percent of the composite. In certain embodiments, the carbon-based material makes up greater than about 1 weight percent of the composite, greater than about 2 weight percent of the composite, greater than about 5 weight percent of the composite, or greater than about 7 weight percent of the composite, for example

In certain embodiments, the step of contacting the polymer and the masterbatch includes resin kettle mixing and/or extruder mixing (i.e. single-screw or twin-screw extruder).

In one embodiment of the invention, the carbon-based material includes graphite and the method includes the step of contacting the MPO and the graphite. The graphite is preferably in exfoliated form, where exfoliation may take place before, during, or even after contact with the MPO (for example, in one embodiment, the graphite is exfoliated during polymerization of the MPO to polymer). In one embodiment, the graphite is intercalated with MPO during the contacting step, and, optionally, the graphite is exfoliated during polymerization of the MPO to polymer.

In one embodiment, the contacting of the MPO and the graphite is conducted at an elevated temperature, for example, within a range from about 120° C. to about 200° C. In one embodiment, the elevated temperature is above about 100° C. In one embodiment, the elevated temperature is no greater than about 180° C. In one embodiment, the elevated temperature is no greater than about 140° C. Preferably, the MPO is at least partially melted during at least part of the contacting step. In one embodiment, at least part of the contacting step is conducting using an extruder. The extruder may be a single- or twin-screw extruder. Preferably, the extruder performs both dispersive and distributive mixing. In one embodiment, the contacting step includes contacting at least two components of the mixture in at least one process as follows: rotational molding, injection molding, compression molding, pultrusion, resin film infusion, solvent prepreg, hot melt prepreg, resin transfer molding, filament winding, and roll wrapping. In one embodiment, even where the graphite is present in exfoliated form during (or before) the contacting step, the contacting step may be performed without adding solvent to the mixture.

In one embodiment, the masterbatch further includes a catalyst. The method may further include the step of heating the composite to polymerize the MPO, for example, in the presence of the catalyst. The polymerization of the MPO may take place during contacting of the MPO with graphite to disperse the graphite in the masterbatch, or the polymerization may take place after the contacting step, or the contacting step and the polymerization step may overlap (for example, the MPO may be partially polymerized during the initial contacting step). In one embodiment, the heating step to polymerize MPO is conducted below about 220° C., below about 210° C., below about 200° C., below about 190° C., or below about 180° C. Polymerization may be performed at temperatures at or above 220° C. as well. In one embodiment, the polymerized product is a nanocomposite. In one embodiment, the carbon-based material includes graphite in exfoliated form during and/or before the contacting step. In an alternative embodiment, the graphite is intercalated with macrocyclic polyester oligomer during the contacting step, and the graphite becomes exfoliated during the heating (polymerization) step.

For most applications, it is usually not necessary to use solvent to adequately disperse the carbon-based material in MPO to make the masterbatch. However, in an alternate embodiment, the mixture includes an organic solvent during at least part of the contacting of the MPO with the carbon-based material. The organic solvent may include one or more of the following: an alkane, tetradecane, hexadecane, xylene, ortho-xylene, methylene chloride, chlorobenzene, dichlorobenzene, ortho-dichlorobenzene, naphthalene, toluene, tetramethylbenzene, and methylnaphthalene, a perfluorocompound, perfluoro(tri-n-butylamine), and perfluoro(tri-n-pentylamine).

In one embodiment, the composite is electrically conductive, thermally conductive, or both. In a preferred embodiment, the carbon-based material is substantially homogeneously dispersed in the composite. For example, the carbon-based material is dispersed well enough to provide an increase in electrical conductivity of 3, 4, 5, 6, 7, 8, or more orders of magnitude, or an increase in thermal conductivity of 1, 2, or more orders of magnitude, or both, as compared to the mixture without the carbon-based material. In a preferred embodiment, the carbon-based material includes graphite in exfoliated form. For example, the mixture may contain from about 1 to about 5 weight percent exfoliated graphite; the mixture may contain more than 5 weight percent exfoliated graphite; or the mixture may contain below about 1 weight percent exfoliated graphite. In one embodiment, the mixture contains no more than about 5 weight percent exfoliated graphite, yet is electrically conductive.

In another aspect, the invention relates to a composition including a polymer, a carbon-based material, and a cyclic oligomer. In one embodiment, the cyclic oligomer is a carrier for the carbon-based material. In certain embodiments, the composition contains up to about 2 wt. % cyclic oligomer, up to about 4 wt. % cyclic oligomer, up to about 6 wt. % cyclic oliogomer, up to about 8 wt. % cyclic oligomer, or up to about 10 wt. % cyclic oligomer, although higher amounts of cyclic oligomer may be used.

In certain embodiments, the cyclic oligomer includes at least one of the following: a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and/or a co-oligomer thereof. In certain embodiments, the cyclic oligomer includes an MPO. The MPO may include one or more of the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and/or copolyester oligomer comprising two or more monomer repeat units. In certain embodiments, the cyclic oligomer includes a lactone, caprolactone, and/or a lactic acid dimer.

In certain embodiments, the polymer includes at least one of the following: a polyester, a polyolefin, a polyformal, a polyphenylene oxide, a polyphenylene sulfide, a polyphenylsulfone, a polyetherimide, and/or a co-polymer thereof. In certain embodiments, the polymer includes a linear polymer. In certain embodiments, the polymer includes a polyester. In certain embodiments, the cyclic oligomer includes a species having a monomeric unit in common with a monomeric unit of at least one species of the polymer.

In certain embodiments, the carbon-based material includes one or more of the following: carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, and/or buckytubes. In certain embodiments, the carbon-based material includes carbon nanotubes. In certain embodiments, the carbon-based material includes graphite, for example, exfoliated graphite. For example, the composition may include from about 1 to about 5 weight percent exfoliated graphite.

Preferably, the composition is electrically conductive, thermally conductive, or both. In certain embodiments, the composition is a nanocomposite. In certain embodiments, the carbon-based material makes up no more than about 5 weight percent of the composition, yet the composition is electrically conductive. In certain embodiments, the carbon-based material makes up no more than about 7 weight percent of the composition, yet the composition is electrically conductive. In certain embodiments, the carbon-based material makes up no more than about 4 weight percent of the composition, yet the composition is electrically conductive. In certain embodiments, the carbon-based material makes up no more than about 3 weight percent of the composition, yet the composition is electrically conductive.

In certain embodiments, the carbon-based material makes up less than or equal to about 10 weight percent of the composition, less than or equal to about 7 weight percent of the composition, less than or equal to about 5 weight percent of the composition, less than or equal to about 3 weight percent of the composition, less than or equal to about 2 weight percent of the composition, or less than or equal to about 1 weight percent of the composition. In certain embodiments, the carbon-based material makes up greater than about 1 weight percent of the composition, greater than about 2 weight percent of the composition, greater than about 5 weight percent of the composition, or greater than about 7 weight percent of the composition, for example.

In certain embodiments, the invention relates to a manufacturing process, for example, a molding/injection molding process, using any of the compositions or composites described above. In certain embodiments, for example, involving injection molding, the presence of cyclic oligomer—e.g. MPO—allows reduced energy consumption.

In another aspect, the invention relates to a linear polymer composition containing up to about 10 wt. % cyclic oligomer as flow modifier. The cyclic oligomer is preferably a macrocyclic oligomer. In certain embodiments, the amount of cyclic oligomer is less than about 7 wt. %, less than about 5 wt. %, less than about 3 wt. %, less than about 2 wt. %, less than about 1 wt. %, or less than about 0.5 wt. %. In certain embodiments, the amount of cyclic oligomer used in between about 0.5 wt. % and about 3 wt. %.

In certain embodiments, the cyclic oligomer used as flow modifier includes a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and/or co-oligomers thereof. In some embodiments, the cyclic oligomer contains or is a macrocyclic polyester oligomer, for example, a macrocyclic poly(butylene terephthalate) oligomer, a macrocyclic poly(ethylene terephthalate) oligomer, and/or co-oligomers thereof. The macrocyclic polyester oligomer may be aliphatic or aromatic, for example.

In one embodiment, the cyclic oligomer includes a lactone, a caprolactone (i.e. cyclic poly(caprolactone) oligomer), and/or a lactic acid dimer.

The linear polymer composition may have as its linear polymer one or more polyesters, polyolefins, polyformals, polyphenylene oxides, polyphenylene sulfides, polyphenylsulfones, polyetherimides, and/or co-polymers thereof. In some embodiments, the linear polymer is a polyester. In certain embodiments, the linear polymer includes polybutylene terephthalate (PBT), polyethylene terephthalate (PET), and/or copolyesters thereof.

The cyclic oligomer(s) and the linear polymer may have monomeric units that are the same as each other, or are different. For example, cyclic poly(butylene terephthalate) oligomer may be used as a flow modifier for PBT (where the monomeric units of the cyclic oligomer and the linear polymer are the same), while cyclic poly(butylene terephthalate) oligomer may also be used as a flow modifier for PET (where the monomeric units of the cyclic oligomer and the linear polyer are different).

In certain embodiments, the invention relates to a manufacturing process (for example, a molding process, or more particularly, an injection molding process) involving one or more of the compositions above. In certain embodiments, use of the composition allows reduced energy consumption of the manufacturing process.

In another aspect, the invention relates to a method for preparing bottle preforms, the method including the steps of preparing one or more of the above-described compositions, and injection molding the composition(s) to form a bottle preform. In certain embodiments, the method further includes the step of blow molding a bottle from the bottle preform, where the optical properties of the bottle are substantially unaffected by the use of the cyclic oligomer as flow modifier. In some embodiments, the presence of the cyclic oligomer in the composition allows for a reduction of at least about 5%, 10%, 15%, 18%, or 20% in switch over pressure.

### DETAILED DESCRIPTION

Exfoliated graphite and/or other carbon-based material may be homogeneously dispersed in molten MPO without excessive increase in melt viscosity. Furthermore, MPO can be used as a carrier/agent for dispersal/mixing of carbon-based material, such as graphite, exfoliated graphite, carbon nanotubes, and the like, into polymer.

It is possible to create stable mixtures of MPO, exfoliated graphite (and/or other carbon-based materials/fillers), and polymerization catalyst that can be stored in a convenient form and that can be polymerized to form polymer composites having high electrical and/or thermal conductivities. Furthermore, because polymerization may be conducted at temperatures below the melting point of the resulting polymer, thermal cycle times are reduced. For example, a mold in which a molten MPO-containing mixture is injected does not have to be cooled before releasing the polymerized product, because melt flow, polymerization, and crystallization can occur isothermally (or, in any event, below the melting point of the polymer). Also, due to the low melt viscosity of MPO and the compatibility of MPO with exfoliated graphite and/or other similar carbon-based material, larger amounts of the high aspect ratio filler can be incorporated and dispersed on a nano-scale.

Throughout the description, where compositions, mixtures, blends, and composites are described as having, including, or comprising specific components, or where processes and methods are described as having, including, or comprising specific steps, it is contemplated that, additionally, there are compositions, mixtures, blends, and composites of the present invention that consist essentially of, or consist of, the recited components, and that there are processes and methods of the present invention that consist essentially of, or consist of, the recited processing steps.

Where graphite-containing composites and compositions are discussed herein, it is contemplated that alternative embodiments include any carbon-based material or filler in place of graphite. Examples of carbon-based materials/fillers include carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, and buckytubes.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Scale-up of systems from laboratory to plant scale (including pilot plant scale) may be performed by those skilled in the field of polymer manufacturing and processing.

The following general definitions may be helpful in understanding the various terms and expressions used in this specification.

Definitions

As used herein, “macrocyclic” is understood to mean a cyclic molecule having at least one ring within its molecular structure that contains 5 or more atoms covalently connected to form the ring.

As used herein, an “oligomer” is understood to mean a molecule that contains one or more identifiable structural repeat units of the same or different formula.

As used herein, a “macrocyclic polyester oligomer” (MPO) is understood to mean a macrocyclic oligomer containing structural repeat units having an ester functionality. A macrocyclic polyester oligomer typically refers to multiple molecules of one specific repeat unit formula. However, a macrocyclic polyester oligomer also may include multiple molecules of different or mixed formulae having varying numbers of the same or different structural repeat units. In addition, a macrocyclic polyester oligomer may be a co-polyester or multi-component polyester oligomer, i.e., an oligomer having two or more different structural repeat units having ester functionality within one cyclic molecule.

As used herein, “substantially homo- or co-polyester oligomer” is understood to mean a polyester oligomer wherein the structural repeat units are substantially identical or substantially composed of two or more different structural repeat units, respectively.

As used herein, an “alkylene group” is understood to mean —CₙH₂ₙ—, where n≧2.

As used herein, a “cycloalkylene group” is understood to mean a cyclic alkylene group, —CₙH₂ₙ₋ₓ—, where x represents the number of H's replaced by cyclization(s).

As used herein, a “mono- or polyoxyalkylene group” is understood to mean [—(CH₂)ₘ—O—]ₙ—(CH₂)ₘ—, wherein m is an integer greater than 1 and n is an integer greater than 0.

As used herein, a “divalent aromatic group” is understood to mean an aromatic group with links to other parts of the macrocyclic molecule. For example, a divalent aromatic group may include a meta- or para-linked monocyclic aromatic group (e.g., benzene).

As used herein, an “alicyclic group” is understood to mean a non-aromatic hydrocarbon group containing a cyclic structure within.

As used herein, a “C₁₋₄ primary alkyl group” is understood to mean an alkyl group having 1 to 4 carbon atoms connected via a primary carbon atom.

As used herein, a “C₁₋₁₀ alkyl group” is understood to mean an alkyl group having 1 to 10 carbon atoms, including straight chain or branched radicals.

As used herein, a “methylene group” is understood to mean —CH₂—.

As used herein, an “ethylene group” is understood to mean —CH₂—CH₂—.

As used herein, a “C₂₋₃ alkylene group” is understood to mean —CₙH₂H₂ₙ—, where n is 2 or 3.

As used herein, a “C₂₋₆ alkylene group” is understood to mean —CₙH₂ₙ—, where n is 2-6.

As used herein, “substitute phenyl group” is understood to mean a phenyl group having one or more substituents. A substituted phenyl group may have substitution pattern that is recognized in the art. For example, a single substituent may be in the ortho, meta or para positions. For multiple substituents, typical substitution patterns include, for example, 2,6-, 2,4,6-, and, 3,5-substitution patterns.

As used herein, a “filler” is understood to mean a material other than a macrocyclic polyester oligomer or a polymerization catalyst that may be included in a blend containing MPO and which may be present in a polymer composition resulting from polymerization of an MPO-containing blend. A filler may be used to achieve a desired purpose or property, and may be present or transformed into known and/or unknown substances in the resulting polyester polymer. For example, the purpose of the filler may be to provide stability, such as chemical, thermal, or light stability, to the blend material or the polymer composition; to increase the strength of the polymer composition/product; and/or to increase electrical and/or thermal conductivity of the blend material and/or the polymer composition. A filler also may provide or reduce color, provide weight or bulk to achieve a particular density, provide reduced gas and vapor permeability, provide flame or smoking resistance (i.e., be a flame retardant), be a substitute for a more expensive material, facilitate processing, and/or provide other desirable properties. Illustrative examples of fillers are, among others, graphite, exfoliated graphite, carbon nanotubes, graphene, graphite nanoplatelets, exfoliated graphite nanoplatelets, graphitic fibers, carbon nanofibers, carbon fibrils, fullerenes, cellulose whiskers, carbon whiskers, buckyballs, buckytubes, carbon black, carbon fibers, buckminsterfullerene, diamond, anhydrous magnesium silicate (anhydrous talc), fumed silica, titanium dioxide, calcium carbonate, wollastonite, chopped fibers, fly ash, glass, glass fiber, milled glass fiber, glass microspheres, micro-balloons, crushed stone, nanoclay, linear polymers, monomers, branched polymers, engineering resin, impact modifiers, organoclays, and pigments. Multiple fillers may be included in MPO blends, for example, to achieve a balance of properties. For example, an impact modifier may be added to an MPO blend containing exfoliated graphite so that the resulting blend and/or polymer composition exhibits high impact resistance as well as high electrical conductivity.

As used herein, a “polymer composition” is understood to mean a polymeric material comprising filler.

As used herein, a “nanocomposite” is understood to mean a polymeric material containing well-dispersed exfoliated filler, where individual particles of the filler have a size on the order of 0 to about 100 nanometers in at least one dimension.

The following headers are provided as a general organizational guide and do not serve to limit support for any given element of the invention to a particular section of the Description.

### I. MACROCYCLIC POLYESTER OLIGOMER

One of the ingredients of the mixtures of the invention is a macrocyclic polyester oligomer, also referred to herein as macrocyclic oligoester and abbreviated herein as MPO. Many different MPO's can readily be made and are useful in the practice of this invention. Thus, depending on the desired properties of the final polymer composition, the appropriate MPO(s) can be selected for use in its manufacture.

MPO's that may be employed in this invention include, but are not limited to, macrocyclic poly(alkylene dicarboxylate) oligomers having a structural repeat unit of the formula: 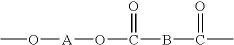
where A is an alkylene, or a cycloalkylene or a mono- or polyoxyalkylene group; and B is a divalent aromatic or alicyclic group.

Preferred MPO's include macrocyclic poly(1,4-butylene terephthalate) (cPBT), macrocyclic poly(1,3-propylene terephthalate) (cPPT), macrocyclic poly(1,4-cyclohexylenedimethylene terephthalate) (cPCT), macrocyclic poly(ethylene terephthalate) (PET), and macrocyclic poly(1,2-ethylene 2,6-naphthalenedicarboxylate) (cPEN) oligomers, and copolyester oligomers comprising two or more of the above monomer repeat units.

MPO's may be prepared by known methods. Synthesis of the preferred MPO's may include the step of contacting at least one diol of the formula HO-A-OH with at least one diacid chloride of the formula: 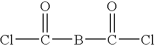
where A and B are as defined above. The reaction typically is conducted in the presence of at least one amine that has substantially no steric hindrance around the basic nitrogen atom. An illustrative example of such amines is 1,4-diazabicyclo[2.2.2]octane (DABCO). The reaction usually is conducted under substantially anhydrous conditions in a substantially water immiscible organic solvent such as methylene chloride. The temperature of the reaction typically is between about −25° C. and about 25° C. See, e.g., U.S. Pat. No. 5,039,783 to Brunelle et al.

MPO's have also been prepared via the condensation of a diacid chloride with at least one bis(hydroxyalkyl) ester such as bis(4-hydroxybutyl) terephthalate in the presence of a highly unhindered amine or a mixture thereof with at least one other tertiary amine such as triethylamine, in a substantially inert organic solvent such as methylene chloride, chlorobenzene, or a mixture thereof. See, e.g., U.S. Pat. No. 5,231,161 to Brunelle et al.

Another method for preparing MPO's is to depolymerize linear polyester polymers in the presence of an organotin or titanate compound. In this method, linear polyesters are converted to macrocyclic polyester oligomers by heating a mixture of linear polyesters, an organic solvent, and a trans-esterification catalyst such as a tin or titanium compound. The solvents used, such as o-xylene and o-dichlorobenzene, usually are substantially free of oxygen and water. See, e.g., U.S. Pat. No. 5,407,984 to Brunelle et al. and U.S. Pat. No. 5,668,186 to Brunelle et al. Production and depolymerization of low-acid polyalkylene terephthalate to prepare MPO is described in co-owned U.S. Patent Application No. 60/665,648, by Phelps et al., the text of which is incorporated by reference herein in its entirety.

MPO's have been prepared from intermediate molecular weight polyesters by contacting a dicarboxylic acid or a dicarboxylate in the presence of a catalyst to produce a composition comprising a hydroxyalkyl-terminated polyester oligomer. The hydroxyalkyl-terminated polyester oligomer is heated to produce a composition comprising an intermediate molecular weight polyester which preferably has a molecular weight between about 20,000 Daltons and about 70,000 Daltons. The intermediate molecular weight polyester is heated and a solvent is added prior to or during the heating process to produce a composition comprising an MPO. See, e.g., U.S. Pat. No. 6,525,164, to Faler.

MPO's that are substantially free from macrocyclic co-oligoesters have been prepared by depolymerizing polyesters using the organo-titanate catalysts described in co-owned U.S. Pat. No. 6,787,632, by Phelps et al., the text of which is incorporated by reference herein in its entirety.

It is also within the scope of the invention to employ macrocyclic homo- and co-polyester oligomers to produce homo- and co-polyester polymers, respectively. Therefore, unless otherwise stated, an embodiment of a composition, article, process, or method that refers to a macrocyclic polyester oligomer also includes a co-polyester embodiments.

In one embodiment, macrocyclic ester homo- and co-oligomers used in this invention include oligomers having a general structural repeat unit of the formula: 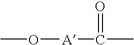
where A′ is an alkylene, cycloalkylene, or mono- or polyoxyalkylene group, and where A′ may be substituted, unsubstituted, branched, and/or linear. Example MPO's of this type include butyrolactone and caprolactone, where the degree of polymerization is one, and 2,5-dioxo-1,4-dioxane, and lactide, where degree of polymerization is two. The degree of polymerization may alternatively be 3, 4, 5, or higher. Molecular structures of 2,5-dioxo-1,4-dioxane and lactide, respectively, appear below:

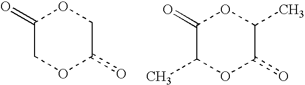

In one embodiment, a macrocyclic polyester oligomer (MPO) used in a mixture of the invention includes species of different degrees of polymerization. Here, a degree of polymerization (DP) with respect to the MPO means the number of identifiable structural repeat units in the oligomeric backbone. The structural repeat units may have the same or different molecular structure. For example, an MPO may include dimer, trimer, tetramer, pentamer, and/or other species.

### II. POLYMERIZATION CATALYST

Polymerization catalysts employed in certain embodiments of the invention are capable of catalyzing the polymerization of MPO. As with state-of-the-art processes for polymerizing MPO's, organotin and organotitanate compounds are the preferred catalysts, although other catalysts may be used. For example, butyltin chloride dihydroxide (i.e. n-butyltin(IV) chloride dihydroxide) may be used as polymerization catalyst. Other illustrative organotin compounds include dialkyltin(IV) oxides, such as di-n-butyltin(IV) oxide and di-n-octyltin oxide, and acyclic and cyclic monoalkyltin (IV) derivatives such as n-butyltin tri-n-butoxide, dialkyltin(IV) dialkoxides such as di-n-butyltin(IV) di-n-butoxide and 2,2-di-n-butyl-2-stanna-1,3-dioxacycloheptane, and trialkyltin alkoxides such as tributyltin ethoxide. Another illustrative organotin compound that may be used as polymerization catalyst is 1,1,6,6-tetra-n-butyl-1,6-distanna-2,5,7,10-tetraoxacyclodecane. See, e.g., U.S. Pat. No. 5,348,985 to Pearce et al.

Also, trisstannoxanes having the general formula (I) shown below can be used as a polymerization catalyst to produce branched polyester polymers.

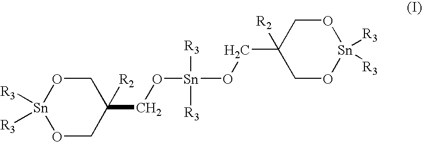

where R₂ is a C₁₋₄ primary alkyl group and R₃ is C₁₋₁₀ alkyl group.

Additionally, organotin compounds with the general formula (II) shown below can be used as a polymerization catalyst to prepare branched polyester polymers from macrocyclic polyester oligomers. 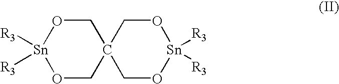
where R₃ is defined as above.

As for titanate compounds, tetra(2-ethylhexyl) titanate, tetraisopropyl titanate, tetrabutyl titanate, and titanate compounds with the general formula (III) shown below can be used as polymerization catalysts. 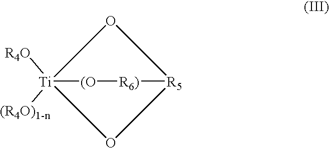
wherein: each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1.

Typical examples of titanate compounds with the above general formula are shown in Table 1.

TABLE 1
Examples of Titanate Compounds Having Formula (III)

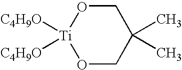

Di-1-butyl 2,2-dimethylpropane-
1,3-dioxytitanate

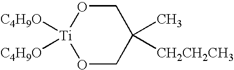

Di-1-butyl 2(1-propyl)-2-
methylpropane-1,3-dioxytitanate

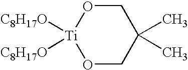

Di(2-ethyl-1-hexyl) 2,2-dimethylpropane-
1,3-dioxytitanate

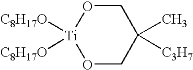

Di(2-ethyl-1-hexyl) 2-(1-propyl)-2-
methylpropane-1,3-dioxytitanate

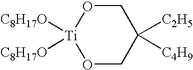

Di(2-ethyl-1-hexyl) 2-(1-butyl)-2-
ethylpropane-1,3-dioxytitanate

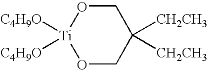

Di-1-butyl 2,2-diethyipropane-
1,3-dioxytitanate

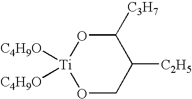

Di-1-butyl 2-ethylhexane-
1,3-dioxytitanate

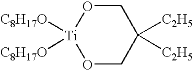

Di(2-ethyl-1-hexyl) 2,2-diethylpropane-
1,3-dioxytitanate

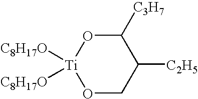

Di(2-ethyl-1-hexyl) 2-ethylhexane-
1,3-dioxytitanate

Titanate ester compounds having at least one moiety of the following general formula have also been used as polymerization catalysts: 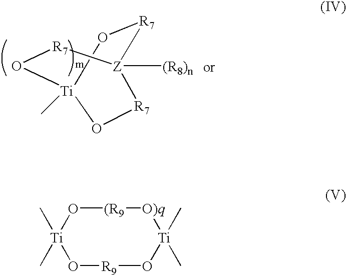
wherein: each R₇ is independently a C₂₋₃ alkylene group; R₈ is a C₁₋₆ alkyl group or unsubstituted or substituted phenyl group; Z is O or N; provided when Z is O, m=n=0, and when Z is N, m=0 or 1 and m+n=1; each R₉ is independently a C₂₋₆ alkylene group; and q is 0 or 1.

Typical examples of such titanate compounds are shown below as formula (VI) and formula (VII):

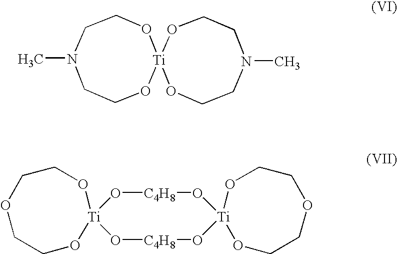

Other polymerization catalysts which may be used in the blend materials of the invention include aryl titanates, described, for example, in co-owned U.S. Pat. No. 6,906,147, by Wang, the text of which is incorporated by reference herein in its entirety. Also, polymer-containing organo-metal catalysts may be used in the invention. These include the polymer-containing catalysts described in co-owned U.S. Pat. No. 6,831,138, by Wang, the text of which is incorporated by reference herein in its entirety.

### III. PREPARATION OF MIXTURES INCLUDING MPO AND GRAPHITE (EXFOLIATED AND NON-EXFOLIATED)

Graphite (exfoliated and/or non-exfoliated) may be blended with a macrocyclic polyester oligomer (MPO), for example, via melt-mixing, powder mixing, and/or extrusion. Preferably, the graphite is added to MPO before polymerization of the MPO, to facilitate homogenous dispersion due to the low viscosity of MPO and/or to enhance the ultimate dispersion of graphite in the polymerized product. In an alternative embodiment, the MPO is partially polymerized at the time of introduction of the graphite.

Preparing a graphite-MPO mixture preferably includes contacting the graphite and MPO at a temperature in which all, substantially all, or a significant proportion (for example, more than about 30 wt. %, more than about 60 wt. %, or, preferably, more than about 90 wt. %) of the MPO is melted. In certain embodiments, exfoliated graphite and MPO are powder-mixed before heating to melt the MPO. Where the mixture contains catalyst, dispersion of mixture components and polymerization of the MPO may be accomplished, for example, in one heating step. In other embodiments, catalyst, graphite, and MPO are melt-mixed, cooled, processed (i.e. powdered), and stored before a separate polymerization step.

In an embodiment where the MPO comprises macrocyclic poly(butylene terephthalate) oligomer in a substantial proportion, graphite is preferably added to the MPO when the MPO is at a temperature from about 120° C. to about 200° C., for example. Contact of the graphite with MPO preferably includes or is combined with mixing, extrusion, or any other process that enhances the dispersion of graphite in MPO. The process may be a batch process, or it may be continuous or semi-continuous. In one embodiment, “melt-mixing” occurs as a mixture of MPO and graphite is extruded, and the extrudate is quenched.

It is advantageous that the graphite be present in the polymer composition in exfoliated form. Exfoliation of the graphite may take place at any time using any suitable exfoliation technique, for example, chemical treatment and/or application of heat and/or shear. For example, in one embodiment, the graphite may be acid-intercalated and heat treated to produce exfoliated graphite before being mixed with low-viscosity MPO. The mixture can then be polymerized to form a polymer composition containing exfoliated graphite. In another embodiment, the graphite is contacted with MPO in non-exfoliated form, but becomes exfoliated during processing of the mixture and/or during polymerization of the mixture to form MPO. Application of shear and/or heat, i.e., in an extruder and/or internal mixer, may serve to sufficiently exfoliate the graphite, thereby contributing to the desired electrical and/or thermal properties of the polymer composition. In another embodiment, the graphite is partially exfoliated prior to introduction to the MPO. The graphite in the mixture may then be further exfoliated by application of shear and/or heat to the mixture if further exfoliation of the graphite is desired.

An appropriate catalyst—for example, a zinc-, titanium-, or tin-containing polymerization catalyst such as those described herein above—may be added before, during, or after the graphite is contacted (and preferably mixed) with the macrocyclic oligoester to produce a one-part, ready-to-use material. In one embodiment of the invention, the amount of polymerization catalyst employed is generally an amount from about 0.01 to about 10.0 mole percent, preferably from about 0.1 to about 2 mole percent, and more preferably from about 0.2 to about 0.6 mole percent, based on total moles of repeat units of the MPO.

In an alternative embodiment, the MPO-graphite mixture does not contain polymerization catalyst. For example, the MPO-graphite mixture initially consists essentially of MPO and graphite or MPO, graphite, and other filler(s) and/or polymer, but not catalyst. This type of mixture gives rise to a “two-part” polymerization system, where the polymerization catalyst is provided separately. For example, the graphite-MPO mixture can be added to a reaction vessel at a different time, or via a different mechanism, than the polymerization catalyst. In one embodiment, the graphite-MPO mixture is extruded or injection-molded together with a separately-provided polymerization catalyst.

The mixtures of the invention may be used in any combination of one or more processes—for example (and without limitation), rotational molding, injection molding, powder coating, compression molding, extrusion, pultrusion, resin film infusion, solvent prepreg, hot melt prepreg, resin transfer molding, filament winding, and roll wrapping processes. Articles produced by these processes are encompassed within the scope of this invention. Examples of these processes are provided in co-owned U.S. Pat. No. 6,369,157, by Winckler et al., and co-owned U.S. Pat. No. 6,420,047, by Winckler et al., the texts of which are incorporated by reference herein, in their entirety. The graphite-MPO mixtures of the invention generally exhibit higher melt viscosities than unfilled MPO. Therefore, these mixtures may be particularly well-suited for use in low-pressure processes such as rotational molding, powder coating, low-pressure molding, gas-assist molding, short-shot molding, co-injection molding, reaction-injection molding, blow molding, thermoforming, and combinations thereof, where a higher melt viscosity is desired.

In an alternative embodiment, graphite (exfoliated, partially-exfoliated, or non-exfoliated) is added during depolymerization of polyester into MPO. As described herein above, MPO may be prepared by depolymerizing linear polyesters in the presence of an organotin or organotitanate and, optionally, solvent, which may or may not be substantially free of oxygen and/or water. Graphite may be introduced at a suitable point during depolymerization of polyester into MPO, thereby forming a composite containing graphite and MPO. Preferably, the graphite is exfoliated before addition to the depolymerization mixture; however, depolymerization conditions may be such that the graphite becomes sufficiently exfoliated after it is added to the depolymerization mixture (i.e. upon application of sufficient heat and/or shear).

### IV. MIXTURES OF MPO AND GRAPHITE AND/OR OTHER CARBON-BASED FILLERS

An embodiment of the invention provides a mixture including an MPO and graphite. In a preferred embodiment, the graphite is substantially homogeneously dispersed in the mixture. For example, the graphite is dispersed well enough to provide an increase in electrical conductivity of 3, 4, 5, 6, 7, 8, or more orders of magnitude, or an increase in thermal conductivity of 1, 2, or more orders of magnitude, or both, as compared to the MPO without graphite. The mixture may be an intimate physical mixture or a nanocomposite, for example. In one embodiment, the graphite is exfoliated graphite. For example, the mixture may contain from about 1 to about 5 weight percent exfoliated graphite; the mixture may contain more than 5 weight percent exfoliated graphite; or the mixture may contain below about 1 weight percent exfoliated graphite. In one embodiment, the mixture is electrically conductive. For example, in one embodiment the mixture contains no more than about 5 weight percent exfoliated graphite, yet is electrically conductive. The mixture may contain one or more fillers in addition to graphite.

The MPO in the mixture preferably includes a macrocyclic poly(alkylene dicarboxylate) oligomer having a structural repeat unit of the formula: 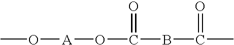
where A is an alkylene, or a cycloalkylene or a mono- or polyoxyalkylene group; and B is a divalent aromatic or alicyclic group. In one embodiment, the MPO comprises at least one of the following: macrocyclic poly(1,4-butylene terephthalate), macrocyclic poly(1,3-propylene terephthalate), macrocyclic poly(1,4-cyclohexylenedimethylene terephthalate), macrocyclic poly(ethylene terephthalate), and macrocyclic poly(1,2-ethylene 2,6-naphthalenedicarboxylate) oligomers, and copolyester oligomers comprising two or more monomer repeat units. In one embodiment, the MPO includes butylene terephthalate units and ethylene terephthalate units. The MPO in the mixture may include one or more species. The species may have different degrees of polymerization.

In one embodiment, the mixture further includes a polymerization catalyst. The catalyst may include, for example, a titanium-containing compound, a tin-containing compound, or both. In one embodiment, the catalyst includes at least one of the following: a tetraalkyl titanate, tetrakis(2-ethylhexyl) titanate, tetrabutyl titanate, tetraisopropyl titanate, tetramethyl titanate, tetraethyl titanate, diisopropyl bis(2,4-pentanedionate) titanate, tetrakis(4-hydroxybutyl) titanate, an alkyltin tricarboxylate, a dialkyltin, a dialkyltin oxide, a dialkyltin alkoxide, a stannoxane, and a spiro tin compound. In one embodiment, the catalyst includes butyltin chloride dihydroxide. The mixture including the polymerization catalyst is preferably stable at ambient conditions for at least one week, at least one month, or longer.

The mixture may be polymerized, for example, in a two-part system, where the MPO-graphite mixture is exposed to a temperature sufficient to melt the MPO, and the resulting mixture is contacted with a polymerization catalyst whereupon polymerization and crystallization occur substantially isothermally, thereby forming a polymeric composition including polymer and graphite. The polymerization may take place in any molding, casting, or forming process, for example, an injection molding process, a rotational molding process, a resin film infusion process, a solvent prepreg process, a hot melt prepreg process, an extrusion process, a pultrusion process, a resin transfer molding process, a filament winding process, a compression molding process, a roll wrapping process, a powder coating process, and combinations thereof. The time and expense required to thermally cycle a tool is favorably reduced, for example, because demolding can take place immediately following polymerization, without first cooling the mold, because, for example, the polymerization temperature is well below the melting point of the resulting polymer.

Alternatively, the MPO-graphite mixture may be stored as a one-part, ready-to-polymerize blend including MPO, graphite, and a polymerization catalyst. The one-part blend remains stable for at least a week, for at least a month, or for at least a year or more, without significant premature polymerization of MPO and without significant deactivation of catalyst. When it is desired to polymerize the MPO, the one-part blend is exposed to a temperature sufficient to melt and polymerize the MPO, whereupon polymerization and crystallization occur substantially isothermally.

One embodiment of the invention includes a polymer composition resulting from the polymerization of at least one component of the mixture. Preferably, the polymer composition is a nanocomposite in which the graphite particles have a size on the order of 0 to about 100 nanometers in at least one dimension. The polymer composition may be electrically conductive, thermally conductive, or both. In a preferred embodiment, the graphite is substantially homogeneously dispersed in the polymer composition. For example, the graphite is dispersed well enough to provide an increase in electrical conductivity of 3, 4, 5, 6, 7, 8, or more orders of magnitude, or an increase in thermal conductivity of 1, 2, or more orders of magnitude, or both, as compared to the polymer composition without graphite. In a preferred embodiment, the graphite is present in the polymer composition in exfoliated form. For example, the polymer composition may contain from about 1 to about 5 weight percent exfoliated graphite; the polymer composition may contain more than 5 weight percent exfoliated graphite; or the polymer composition may contain below about 1 weight percent exfoliated graphite. In one embodiment, the polymer composition contains no more than about 5 weight percent exfoliated graphite, yet is electrically conductive.

In one embodiment, the graphite-MPO mixture has a relatively low viscosity. For example, where the mixture contains at least about 2 weight percent exfoliated graphite, the melt viscosity of the mixture (the viscosity of the mixture at a temperature between about 150° C. and about 200° C.) is less than about 2000 cP, is less than about 1000 cP, is less than about 500 cP, or is less than about 200 cP.

### V. EXPERIMENTAL EXAMPLES

Experimental examples 1-9 demonstrate preparation of exemplary stable, one-part, ready-to-polymerize, intimate physical mixtures (or nanocomposites) comprising MPO, graphite, and polymerization catalyst. Volume resistivities of the polymer compositions are shown in Table 2. Volume resistivity dramatically decreased from 1.1×10¹² Ω·cm for unfilled polymer (PBT) to 6.4×10² Ω·cm for the polymer composite containing 5 wt. % exfoliated graphite. The presence of exfoliated graphite in the polymer composition renders the composition electrically conductive, even where the polymer without graphite filler is substantially nonconductive.

Examples 1-9 employ the use of macrocyclic polyester oligomers manufactured by Cyclics Corporation of Schenectady, N.Y., that are primarily composed of macrocyclic poly(1,4-butylene terephthalate) oligomer. The MPO used in Examples 1-9 contains about 94 mol. % (1,4-butylene terephthalate) units and about 6 mol. % (2,2′-oxydiethylene terephthalate) units, and is referred to hereinbelow as cPBT, for simplicity. The MPO used in Examples 1-9 contains about 40.2 wt. % dimer species, about 39.0 wt. % trimer species, about 5.5 wt. % tetramer species, about 12.9 wt. % pentamer species, and about 2.4 wt. % higher oligomer species.

In one embodiment of the invention, the MPO of the blend material is a composition comprising from about 30 to about 45 wt. % dimer species, from about 30 to about 45 wt. % trimer species, from about 0 to about 10 wt. % tetramer species, and from about 5 wt. % to about 20 wt. % pentamer species. MPO formulations outside these ranges may be used, as well. Certain embodiments of the invention may include modifying compositions of MPO's. Various exemplary methods of modifying compositions of MPO's are described in co-owned U.S. Pat. No. 6,436,548, by Phelps, the text of which is incorporated by reference herein in its entirety.

Conventional non-exfoliated graphite powders TG 344 and TG 406 were obtained from UCAR Carbon Company, Inc., of Parma, Ohio. Exfoliated graphite was obtained from UCAR Carbon Company, Inc., as well. The polymerization catalyst used was butyltin chloride dihydroxide obtained from Sigma-Aldrich Corporation of St. Louis, Mo.

### Example 1

A first formulation (control) containing no graphite was prepared by placing about 3.2 grams of a cPBT/catalyst blend in a culture tube (25-mm OD×100-mm L), which was lined with a Teflon sheet and equipped with a vacuum adapter. The cPBT/catalyst blend contained MPO mixed with about 0.35 mol % of polymerization catalyst, butyltin chloride dihydroxide. The contents of the tube were dried under vacuum at 100° C. for about one hour and then heated at 190° C. under nitrogen for about 40 minutes to polymerize the MPO. The resulting PBT disk had a thickness of about 8 mm and a diameter of about 20 mm. The surfaces of the disk were polished and the disk was subjected to an electrical conductivity test for quantifying volume resistivity in accordance with a standard test method, ASTM D257-93.

### Example 2

A second formulation containing about 2.0 wt. % of TG344 graphite was prepared by placing about 19.6 grams of the cPBT/catalyst blend described in Example 1 and about 0.4 gram (2 wt. %) of TG344 graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The GPC peak molecular weight of the resulting polymer was about 142,000 Daltons and the polymer conversion was 95.8%. The surfaces of the polymer disk were polished and the disk was subjected to the conductivity test for quantifying volume resistivity in accordance with ASTM D257-93.

### Example 3

A third formulation containing about 5.0 wt. % of TG344 graphite was prepared by placing about 19.0 grams of the cPBT/catalyst blend described in Example 1 and about 1.0 gram (5 wt. %) of TG344 graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The surfaces of the polymer disk were polished and the disk was subjected to the conductivity test for quantifying volume resistivity in accordance with ASTM D257-93.

### Example 4

A fourth formulation containing about 2.0 wt. % of TG406 graphite was prepared by placing about 19.6 grams of the cPBT/catalyst blend described in Example 1 and about 0.4 gram (2 wt. %) of TG406 graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The GPC peak molecular weight of the resulting polymer was about 150,000 Daltons and the polymer conversion was 94.6%. The surfaces of the polymer disk were polished and the disk was subjected to the conductivity test for quantifying volume resistivity in accordance with ASTM D257-93.

### Example 5

A fifth formulation containing about 5.0 wt. % of TG406 graphite was prepared by placing about 19.0 grams of the cPBT/catalyst blend described in Example 1 and about 1.0 gram (5 wt. %) of TG406 graphite powder in ajar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The surfaces of the polymer disk were polished and the disk was subjected to the conductivity test for quantifying volume resistivity in accordance with ASTM D257-93.

### Example 6

A sixth formulation containing about 2.0 wt. % of exfoliated graphite was prepared by placing about 19.6 grams of the cPBT/catalyst blend described in Example 1 and about 0.4 gram (2 wt. %) of exfoliated graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The GPC peak molecular weight of the resulting polymer was about 149,000 Daltons and the polymer conversion was 94.1%. The conversion and molecular weight of the polymer composition containing 2.0 wt. % exfoliated graphite is in line with the conversion and molecular weight of polymer compositions of Examples 2 and 4 containing 2.0 wt. % non-exfoliated graphite. The surfaces of the polymer disk were polished and the disk was subjected to the conductivity test for quantifying volume resistivity in accordance with ASTM D257-93.

### Example 7

A seventh formulation containing about 3.0 wt. % of exfoliated graphite was prepared by placing about 19.4 grams of the cPBT/catalyst blend described in Example 1 and about 0.6 gram (3 wt. %) of exfoliated graphite powder in ajar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The surfaces of the polymer disk were polished and the disk was subjected to the conductivity test for quantifying volume resistivity in accordance with ASTM D257-93.

### Example 8

An eighth formulation containing about 4.0 wt. % of exfoliated graphite was prepared by placing about 19.2 grams of the cPBT/catalyst blend described in Example 1 and about 0.8 gram (4 wt. %) of exfoliated graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The surfaces of the polymer disk were polished and the disk was subjected to the conductivity test for quantifying volume resistivity in accordance with ASTM D257-93.

### Example 9

A ninth formulation containing about 5.0 wt. % of exfoliated graphite was prepared by placing about 19.0 grams of the cPBT/catalyst blend described in Example 1 and about 1.0 gram (5 wt. %) of exfoliated graphite powder in a jar and manually shaking the jar for about a minute. The mixture was placed in a 100 mL, 3-neck flask and dried under vacuum at 100° C. for about one hour. The flask was then placed in a 165° C. oil bath for about 13 minutes until the mixture melted completely. The flask was transferred to a 150° C. oil bath, and the mixture was equilibrated at this temperature under an argon atmosphere. About 87.4 mg (0.35 mmol) of butyltin chloride dihydroxide (polymerization catalyst) was added, and the mixture was stirred under vacuum for about 10 minutes. The resulting mixture was rapidly cooled by pouring and spreading it onto aluminum foil. The black solid was annealed in a vacuum oven at about 80° C. for about two hours and pulverized into a powder. About 3.2 grams of the powdered cPBT/graphite mixture was placed in a culture tube (25-mm OD×100-mm L), which was lined with a Teflon sheet and equipped with a vacuum adapter. The contents of the tube were dried under vacuum at 100° C. for about one hour. The mixture was polymerized under argon at about 190° C. for about 40 minutes and then annealed at about 100° C. for about 60 minutes. The surfaces of the polymer disk were polished and the disk was subjected to the conductivity test for quantifying volume resistivity in accordance with ASTM D257-93.

Table 2 shows volume resistivity measurements for the composites prepared in Examples 1-9. The data indicates a dramatic reduction in volume resistivity from 1.1×10¹² Ω·cm for unfilled polymer (Example 1) to 6.4×10² Ω·cm is achieved for the polymer composite containing 5 wt. % exfoliated graphite (Example 9). Thus, a reduction in volume resistivity of between 9 and 10 orders of magnitude is due to the presence of the homogeneously-dispersed exfoliated graphite in the composite (resistivity is inversely proportional to conductivity). The addition of as little as 3 wt. % exfoliated graphite reduced volume resistivity by between 2 and 3 orders of magnitude (Example 7, compared with Example 1). A reduction in volume resistivity was not achieved using the non-exfoliated graphite (Examples 2-5); thus, the presence of graphite in exfoliated form appears to be important in obtaining a sufficiently disperse graphite-polymer composite to achieve an electrically conductive polymer composite containing relatively low amounts of graphite (up to about 5 wt. %).

TABLE 2
Volume Resisitivites of Graphite-Polymer Composites

| | | Graphite | |
|---|---|---|---|
| Example | | content | Volume resistivity |
| No. | Graphite Type | (wt. %) | (Ω · cm) |
| 1 | None | 0 | 1.1 × 10¹² |
| 2 | TG 344 powder | 2.0 | 11.9 × 10¹² |
| 3 | TG 344 powder | 5.0 | 4.81 × 10¹² |
| 4 | TG 406 powder | 2.0 | 1.66 × 10¹² |
| 5 | TG 406 powder | 5.0 | 10.5 × 10¹² |
| 6 | Exfoliated graphite | 2.0 | 2.03 × 10¹² |
| 7 | Exfoliated graphite | 3.0 | 5.5 × 10⁹ |
| 8 | Exfoliated graphite | 4.0 | 4.9 × 10⁹ |
| 9 | Exfoliated graphite | 5.0 | 6.4 × 10² |

Experimental examples 10-12 demonstrate use of MPO as a flow modifier for thermoplastics.

Experimental Examples 10-12 involved the use of the linear thermoplastic polyester, polyethylene terephthalate (PET), Eastman Voridian CB12, provided by Eastman Chemical Company of Kingsport, Tenn. The cyclic oligomer used in the experiments is cyclic poly(butylene terephthalate), CBT® 100, which is a macrocyclic polyester oligomer, provided by Cyclics® Corporation of Schenectady, N.Y. This material is referred to herein as cPBT.

### Examples 10a-d

### Demonstration of Improved Melt Flow Rate of Pet Compositions with cPBT as Additive, with Negligible Change in Mechanical Properties

Blends of the above-identified linear thermoplastic PET and cyclic oligomer cPBT were created using a Leistritz LSM 34 mm counter-rotating twin screw extruder, with barrel temperature from about 250° C. to about 280° C., operating at about 150 rpm. Table 3 shows the intrinsic viscosity, melt flow rate, yield strength, Young's modulus, elongation, and “Dart” impact strength of compositions 10a to 10d. Specimens were made and conditioned according to ASTM standard method D5229, and tensile tests were performed at 50 mm/min according to ASTM D638 standard method. High speed puncture tests were performed at 3.3 m/s according to ASTM D3763 standard method. Melt flow index was measured according to ASTM D1238 standard method, and intrinsic viscosity was measured according to ASTM D2857 standard method.

Sample 10a is a control sample of PET that has not been extruded. Sample 10b is a control sample of PET that has been extruded using the twin screw extruder as described above. The properties of sample 10b indicate some change in viscosity and melt flow rate due to the extrusion.

Compositions 10c and 10d were prepared by blending cPBT and PET via twin-screw extrusion as described above. Composition 10c contains about 0.5 wt. % cPBT, with the remainder PET, while composition 10d contains about 3 wt. % cPBT, with the remainder PET.

There is significant increase in melt flow rate (MFR) with the addition of cPBT in compositions 10c and 10d, as shown in Table 3, even with negligible change in the intrinsic viscosity. There is negligible degradation of tensile properties due to the presence of cPBT, as seen in Table 3.

### Example 11

### Injection Molding of Bottle Preforms Made of Pet with cPBT as Additive Demonstrating Reduced Pressure and Reduced Energy Requirement

Injection molding of bottle preforms was performed using PET and using PET with cPBT additive in order to demonstrate the improvement afforded by the use of the additive. In the experiment using only PET, the PET pellets were powdered in a laboratory grinder into a −30 mesh powder using a Waring lab blender. This material was then placed in a hopper for feeding into the injection molding machine. For the experiment using PET with cPBT as additive, PET pellets and cPBT pellets were powdered in a laboratory grinder into a −30 mesh powder using a Waring lab blender to form a composition of 98 wt. % PET and 2 wt. % cPBT. This material was then placed into a hopper for feeding into the injection molding machine.

Resin samples were injection molded on an Arburg 320M reciprocating screw molding machine using a 24.5+/−0.5 g, 20 oz. carbonated soft drink style tool. Process parameters were optimized to achieve a clear part at the lowest possible injection molding temperatures (barrel temperatures=268° C.; mold temperature=58° F.; injection pressure 700 bar; injection speed 3.5 sec). The switch over pressure and cycle times are indicated in Table 4, and the hydraulic energy, thermal energy, and total energy consumption of the injection molding process are shown in Table 5.

A significant reduction in switch over pressure—about a 20% reduction—was observed with the composition of 98 wt. % PET and 2 wt. % cPBT. An overall reduction in total energy consumption was observed, as shown in Table 5.

Acetaldehyde forms when PET degrades, and can alter the taste and smell of the contents of the container. It is preferable that the level of acetaldehyde in the bottle material be low. The acetaldehyde content of the bottle preforms were measured. Three preforms of each type were ground to a small particle size and placed in sealed glass vials, which were placed in a heated block at 150° C. for 30 minutes. A sample of the headspace of each vial was injected into a gas chromatograph and the acetaldehyde content was measured using reference calibration standards. Table 6 shows that the average acetaldehyde content of the bottle preforms made from PET with cPBT additive is no more than that of the bottle preforms made from PET, and in fact, is less.

### Example 12

### Blow Molding of Bottle Preforms of Example 11, Demonstrating Negligible Degradation of Bottle Properties

The bottle preforms made in Example 11 were heated to 100° C. and placed onto a mandrel on a free blow molding device. The preforms were then subjected to axial extension of approximately 0.25″ and then pressurized with air to allow the preform to fully orient.

Optical measurements were performed on a Color Quest II colorimeter, and are shown in Table 7. Optical measurements were performed on both the preforms and the blow molded bottles. The results indicate very small differences or negligible differences in optical properties of the blow-molded bottles made using cPBT additive, versus bottles without the cPBT additive.

TABLE 3
Average Values of Selected Properties for PET Blends.

| | | | | Yield | Young's | | Impact |
|---|---|---|---|---|---|---|---|
| Sample | % CBT | IV | MFR | Strength | Modulus | Elongation | Strength |
| # | 100 ® | dl/gm | g/10 min | MPa | GPa | % | J |
| 10a | 0 (Not | 0.85 | 57 | 52.9 | 2.3 | 241 | 49.6 |
| | extruded) | | | | | | |
| 10b | 0 | 0.72 | 93 | N/A | N/A | N/A | N/A |
| | (Extruded) | | | | | | |
| 10c | 0.5 | 0.72 | 140 | 53.7 | 2.3 | 259 | 51.5 |
| 10d | 3 | 0.7 | 250 | 56.5 | 2.4 | 235 | 50.6 |

TABLE 4
Preform Injection Molding Parameters

| | Actual Temperatures C. | | | | | Switch Over | Cycle |
|---|---|---|---|---|---|---|---|
| | | Zone | Zone | Zone | Zone | pressure | Time |
| Material | Feed | 1 | 2 | 3 | 4 | (Bar) | (sec) |
| PET (As | 268 | 268 | 268 | 268 | 268 | 397.4 | 27.63 |
| Received) | | | | | | | |
| PET/CBT | 268 | 268 | 268 | 268 | 268 | 319.6 | 27.61 |
| 100 2 wt % | | | | | | | |

TABLE 5
Energy Consumption of Injection Molder

| | PET/CBT | | % |
|---|---|---|---|
| Parameter | Blend | PET Control | Difference |
| Hydraulic Energy | 0.988 | 1.036 | 4.6 |
| (KWH/min) | | | |
| Thermal Energy (KWH/min | 0.305 | 0.296 | −3.0 |
| Total Energy Consumption | 1.293 | 1.332 | 2.9 |
| (KWH/min) | | | |

TABLE 6
Acetaldehyde Content of Bottles

| | Acetaldehyde |
|---|---|
| | Content |
| Sample | (micrograms/g) |
| PET/CBT Blend | 7.08 ± 0.25 |
| PET Control | 7.44 ± 0.14 |

TABLE 7
Optical Properties of Blended Preforms and Bottles

| | Sample | | | | |
|---|---|---|---|---|---|
| | L* | a* | b* | Haze | ΔE |
| Bottle | | | | | |
| PET/CBT Blend | 93.86 ± | −0.18 ± | 0.84 ± | 1.77 ± | 5.17 ± |
| | 0.02 | 0.01 | 0.03 | 0.03 | 0.02 |
| PET Control | 93.83 ± | −0.17 ± | 0.83 ± | 1.83 ± | 5.19 ± |
| | 0.04 | 0.01 | 0.01 | 0.04 | 0.04 |
| Preform | | | | | |
| PET/CBT Blend | 81.56 ± | −0.45 ± | 1.84 ± | 9.92 ± | 18.46 ± |
| | 0.22 | 0.17 | 0.04 | 0.15 | 0.23 |
| PET Control | 81.56 ± | −0.37 ± | 1.60 ± | 9.84 ± | 18.44 ± |
| | 0.24 | 0.03 | 0.05 | 0.35 | 0.25 |

TABLE 8
Test Standards used

| | Standard |
|---|---|
| Test | Used |
| Tensile Test (50 mm/min) | ASTM D638 |
| High Speed Puncture | ASTM D3763 |
| (“Dart”) 3.3 m/s | |
| Sample Conditioning | ASTM D5229 |
| Melt Flow Index | ASTM D1238 |
| Intrinsic Viscosity | ASTM D2857 |

Experimental examples 13-15 are constructive examples, describing possible experiments that can be conducted to demonstrate use of MPO as a carrier for carbon nanotube fillers (and/or other carbon-based fillers), and subsequent use of the concentrate letdown into a polymer.

### Example 13

### Resin Kettle Mixing Method for Masterbatch/Concentrate

Place known amount macrocyclic polyester oligomer (MPO; e.g. Cyclics Corporation CBT® 100 resin) in a flask under nitrogen and heat the flask to melt the resin (180-200 deg C.). Add carbon nanotube filler (e.g. Cheap Tubes, Inc. SWNT or MWNT of varying outer diameter sizes) to the molten MPO from 5% up to the maximum amount where the mixture can still be stirred or otherwise processed (due to high viscosity). Pour out and cool the flask contents and then grind to a powder to obtain carbon nanotube concentrates with MPO.

### Example 14

### Extruder Mixing Method for Masterbatch/Concentrate

Prepare powder blends of MPO and carbon nanotube filler (e.g. Cheap Tubes, Inc. SWNT or MWNT of varying outer diameter sizes) such that the mixture can be blended in an extruder within the temperature range of 120-180C (mixtures of 5-70% filler could be possible). The mixture can be isolated, cooled and ground to a powder to obtain carbon nanotube concentrates with MPO.

### Example 15

### Masterbatch/Concentrate Letdowns in Polymers

Concentrates prepared by the above methods (i.e. Examples 13 and 14) can be added to polymers in an extrusion blending process using extrusion conditions appropriate for that particular polymer. The letdown ratios should provide polymers containing up to 10% (or at least much lower than the original concentrate) of the carbon nanotube filler where physical properties and electrical conductivity of the blended material can be measured.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for preparing a composite, the method comprising the step of contacting:
(i) a masterbatch comprising:
(a) a macrocyclic polyester oligomer; and
(b) a carbon-based material comprising at least one member selected from the following: carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, and buckytubes; and
(ii) a polymer.

2. The method of claim 1, wherein the carbon-based material makes up at least about 10 weight percent of the masterbatch.

3. The method of claim 1, wherein the carbon-based material makes up at least about 20 weight percent of the masterbatch.

4. The method of claim 1, wherein the carbon-based material makes up at least about 40 weight percent of the masterbatch.

5. The method of claim 1, wherein the carbon-based material comprises carbon nanotubes.

6. The method of claim 5, wherein the carbon-based material comprises single walled carbon nanotubes, multi-wall carbon nanotubes, or both.

7. The method of claim 1, wherein the macrocyclic polyester oligomer comprises a macrocyclic poly(alkylene dicarboxylate) oligomer having a structural repeat unit of the formula: 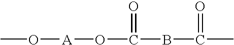
where A is an alkylene, or a cycloalkylene or a mono- or polyoxyalkylene group; and B is a divalent aromatic or alicyclic group.

8. The method of claim 1, wherein the macrocyclic polyester oligomer comprises at least one member selected from the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

9. The method of claim 1, wherein the polymer comprises at least one member selected from the following: a polyester, a polyolefin, a polyformal, a polyphenylene oxide, a polyphenylene sulfide, a polyphenylsulfone, a polyetherimide, and co-polymer thereof.

10. The method of claim 1, wherein the polymer comprises a polyester.

11. The method of claim 10, wherein the polyester comprises at least one member selected from the following: polybutylene terephthalate, polyethylene terephthalate, and co-polyester thereof.

12. The method of claim 1, wherein the polymer is a linear polymer.

13. The method of claim 1, wherein the carbon-based material comprises exfoliated graphite.

14. The method of claim 1, wherein the contacting step comprises contacting the masterbatch with an engineering resin comprising the polymer.

15. The method of claim 1, wherein the polymer comprises at least one of polyethylene terephthalate and polybutylene terephthalate.

16. The method of claim 1, wherein the polymer is thermoplastic.

17. The method of claim 1, wherein the composite is electrically conductive.

18. The method of claim 1, wherein the composite is thermally conductive, electrically conductive, or both.

19. The method of claim 1, wherein the composite is a nanocomposite.

20. The method of claim 1, wherein the carbon-based material makes up no more than about weight percent of the composite, and the composite is electrically conductive.

21. The method of claim 1, wherein the carbon-based material makes up no more than about 10 weight percent of the composite.

22. The method of claim 1, wherein the carbon-based material makes up no more than about 5 weight percent of the composite.

23. The method of claim 1, wherein the carbon-based material makes up no more than about 3 weight percent of the composite.

24. A composition comprising:
(a) polymer;
(b) a carbon-based material; and
(c) cyclic oligomer.

25. The composition of claim 24, wherein the cyclic oligomer is a carrier for the carbon-based material.

26. The composition of claim 24, wherein the composition comprises up to about 10 wt. % cyclic oligomer.

27. The composition of claim 24, wherein the composition comprises up to about 2 wt. % cyclic oligomer.

28. The composition of claim 24, wherein the cyclic oligomer comprises at least one member selected from the following: a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and co-oligomer thereof.

29. The composition of claim 24, wherein the cyclic oligomer comprises a macrocyclic polyester oligomer.

30. The composition of claim 29, wherein the macrocyclic polyester oligomer comprises at least one member selected from the following: macrocyclic poly(1,4-butylene terephthalate) oligomer, macrocyclic poly(1,3-propylene terephthalate) oligomer, macrocyclic poly(1,4-cyclohexylenedimethylene terephthalate) oligomer, macrocyclic poly(ethylene terephthalate) oligomer, macrocyclic poly(1,2-ethylene 2,6-naphthalenedicarboxylate) oligomer, and copolyester oligomer comprising two or more monomer repeat units.

31. The composition of claim 24, wherein the cyclic oligomer comprises at least one member selected from the following: a lactone, a caprolactone, and a lactic acid dimer.

32. The composition of claim 24, wherein the polymer comprises at least one member selected from the following: a polyester, a polyolefin, a polyformal, a polyphenylene oxide, a polyphenylene sulfide, a polyphenylsulfone, a polyetherimide, and co-polymers thereof.

33. The composition of claim 24, wherein the polymer comprises a linear polymer.

34. The composition of claim 24, wherein the polymer comprises a polyester.

35. The composition of claim 24, wherein the cyclic oligomer comprises a species having a monomeric unit in common with a monomeric unit of at least one species of the polymer.

36. The composition of claim 24, wherein the carbon-based material comprises one or more of the following: carbon nanotubes, graphene, graphite, exfoliated graphite, graphite nanoplatelets, exfoliated graphite nanoplatelets, graphitic fibers, carbon nanofibers, carbon fibrils, fullerenes, nanoclays, cellulose whiskers, carbon whiskers, buckyballs, and buckytubes.

37. The composition of claim 24, wherein the carbon-based material comprises carbon nanotubes.

38. The composition of claim 24, wherein the carbon-based material comprises graphite.

39. The composition of claim 24, wherein the carbon-based material comprises exfoliated graphite.

40. The composition of claim 24, wherein the composition contains from about 1 to about 5 weight percent exfoliated graphite.

41. The composition of claim 24, wherein the composition contains more than 5 weight percent exfoliated graphite.

42. The composition of claim 24, wherein the carbon-based material makes up no more than about 5 weight percent of the composition, and the composition is electrically conductive.

43. The composition of claim 24, wherein the carbon-based material makes up no more than about 10 weight percent of the composition.

44. The composition of claim 24, wherein the carbon-based material makes up no more than about 5 weight percent of the composition.

45. The composition of claim 24, wherein the carbon-based material makes up no more than about 3 weight percent of the composition.

46. The composition of claim 24, wherein the composition is electrically conductive, thermally conductive, or both.

47. The composition of claim 24, wherein the composition is a nanocomposite.

48. A manufacturing process using the composition of claim 24.

49. A process for molding the composition of claim 24.

50. An injection molding process using the composition of claim 24, wherein the cyclic oligomer allows reduced energy consumption.

51. A product produced by the method of claim 1.
